(19) United States
(12) Patent Application Publication
(10) Pub. No.: US 2025/0223670 A1
(43) Pub. Date: Jul. 10, 2025

(54) ROLLED MATERIAL

(71) Applicant: PROTERIAL, LTD., Tokyo (JP)

(72) Inventors: Takahiro HORIBE, Osaka (JP); Kimiyasu KATO, Osaka (JP)

(21) Appl. No.: 18/853,036

(22) PCT Filed: Apr. 14, 2023
(86) PCT No.: PCT/JP2023/015144

§ 371 Date: Sep. 30, 2024

(30) Foreign Application Priority Data
May 2, 2022 (JP) 2022-075897

(51) Int. Cl. C22C 14/00

(52) U.S. Cl. CPC C22C 14/00

(57) ABSTRACT

A rolled material includes an alloy or a pure metal, and has an index value, which is used as an index value of durability against bending repetitions, not smaller than 0.014 HV/GPa, the index value=(0.0048×(Vickers hardness)+0.21)/(modulus of elasticity).

### TECHNICAL FIELD

The present invention relates to a rolled material, in particular to a rolled material to be used for a foldable or curvable part.

### BACKGROUND ART

Foldable or curvable parts are known in the art (see Patent Document 1).

For example, Japanese Patent Laid-Open Publication No. JP 2016-59030 discloses a flexible display apparatus including a flexible display and a support supporting the flexible display. In the Japanese Patent Laid-Open Publication No. JP 2016-59030, the support includes a metal plate-like body, and is configured to elastically deform to be foldable or curvable together with the flexible display. The support, which includes the metal plate-like body, is repeatedly bent together with the flexible display.

### PRIOR ART

### Patent Document

Patent Document 1: Japanese Patent Laid-Open Publication No. JP 2016-59030

### SUMMARY OF THE INVENTION

### Problems to be Solved by the Invention

Here, although not disclosed in the above Japanese Patent Laid-Open Publication No. JP 2016-59030, from the viewpoint of design and space saving, a part for a metal plate in the body of the support configured to elastically deform to be foldable or curvable together with the flexible display is desired to reduce a bend radius of the part when bent. However, reduction of the bend radius increases a bending stress on the part (metal plate). For this reason, a part is desired to have good durability to withstand bending stresses applied to the part (metal plate) by bending repetitions.

The present invention is intended to solve the above problem, and one object of the present invention is to provide a rolled material having good durability to withstand bending stresses applied to a metal plate (rolled material) by bending repetitions in elastic deformations.

### Means for Solving the Problems

The inventor of the present application has diligently studied the above problem, and as a result has found that, to improve durability against bending repetitions in elastic deformations, increase of a fatigue limit that does not reach a fracture even when numbers of stresses are applied to the metal plate by bending repetitions, and reduction of a modulus of elasticity, which represents a magnitude of strain caused by a stress, of the metal plate are effective. The invention was then completed.

That is, a rolled material according to one aspect of the present invention is a rolled material to be used for a foldable or curvable part including an alloy or a pure metal, wherein a value that is obtained by the following equation (1) is used as an index value of durability against bending repetitions, and the index value of the rolled material is not smaller than 0.014 HV/GPa,

$$index value = ( 0.0048 \times ( Vickers hardness ) + 0.21 ) / ( modulus of elasticity ) . \qquad ( 1 )$$

The rolled material according to the one aspect of the present invention has an index value, which is used as an index value of durability against bending repetitions, not smaller than 0.014 HV/GPa, the index value=(0.0048×(Vickers hardness)+0.21)/(modulus of elasticity). Here, the inventor of the present application has found that (0.0048×(Vickers hardness)+0.21)/(modulus of elasticity) can be considered as a value of the fatigue limit. Accordingly, in a case in which this index value is not smaller than 0.014 HV/GPa, the fatigue limit becomes sufficiently large so that durability against bending repetitions can be increased. Also, since the modulus of elasticity represents a magnitude of strain caused by a bending stress, reduction of the modulus of elasticity reduces the strain, and as a result it is possible to prevent a fatigue caused by bending repetitions. Consequently, it is possible to provide a rolled material having good durability to withstand bending stresses applied to the metal plate in bending repetitions.

In the rolled material according to the aforementioned one aspect, it is preferable that the index value of the rolled material is not smaller than 0.019 HV/GPa. The inventor of the present application has found that this configuration can provide a sufficient durability against bending repetitions and can further reduce the bend radius of the rolled material based on the experiment.

In the rolled material according to the aforementioned one aspect, it is preferable that the pure metal is pure titanium. The inventor of the present application has found that this configuration using pure titanium can satisfy that the index value of the rolled material is not smaller than 0.014 HV/GPa.

In the rolled material according to the aforementioned one aspect, it is preferable that the alloy is a beta-type titanium alloy, austenitic stainless steel, or beryllium copper. The inventor of the present application has found that this configuration using the beta-type titanium alloy, austenitic stainless steel, or beryllium copper can satisfy that the index value of the rolled material is not smaller than 0.014 HV/GPa.

In this configuration, it is preferable that the beta-type titanium alloy comprises not smaller than 14.0 mass % and not greater than 16.0 mass % of V, not smaller than 2.5 mass % and not greater than 3.5 mass % of Cr, not smaller than 2.5 mass % and not greater than 3.5 mass % of Sn, and not smaller than 2.5 mass % and not greater than 3.5 mass % of Al. The inventor of the present application has found that this configuration can satisfy that the index value of the rolled material is not smaller than 0.014 HV/GPa and bring the bend radius of the rolled material having a thickness of 0.03 mm not greater than 3 mm.

In the rolled material according to the aforementioned one aspect, it is preferable that a value that is obtained by the following equation (2) is used as a prediction value of a minimum bend radius to which the rolled material is foldable or curvable, and the prediction value of the minimum bend radius of the rolled material whose thickness is 0.03 mm is not greater than 2.14 mm,

$$minimum bend radius = ( thickness \times modulus of elasticity ) / ( 0.0048 \times Vickers hardness + 0.21 ) . \qquad ( 2 )$$

According to this configuration, the bend radius can be reduced by adjusting the modulus of elasticity or Vickers hardness to bring the prediction value of the minimum bend radius not greater than 2.14 mm. Also, since prediction of the minimum bend radius can obtain a value of the minimum bend radius to which the rolled material can be considered to be folded or curved without conducting experiments, it is possible to easily design a desired rolled material.

In the rolled material according to the aforementioned one aspect, it is preferable that the rolled material is used for a foldable or curvable support supporting a display of a display apparatus. According to this configuration, it is possible to improve durability against bending repetitions of the support, which is repeatedly folded or curved when the display is repeatedly bent and deformed.

In the rolled material according to the aforementioned one aspect, it is preferable that the rolled material has a thickness not greater than 0.03 mm, and a maximum value of a foldable or curvable bend radius of the rolled material that is actually measured is not greater than 2.1 mm. According to this configuration, since the thickness of the rolled material can be sufficiently small and the bend radius can be sufficiently small, it is possible to use the rolled material for foldable or curvable portable devices.

In the rolled material according to the aforementioned one aspect, it is preferable that the index value of the rolled material is not smaller than 0.014 HV/GPa and not greater than 0.029 HV/GPa. The inventor of the present application has found that the bend radius can be sufficiently reduced by bringing the index value within this range.

### Effect of the Invention

According to the present invention, it is possible to provide a rolled material (metal plate) having good durability to withstand bending stresses applied to the rolled material by bending repetitions in elastic deformations.

### BRIEF DESCRIPTION OF THE DRAWINGS

FIG. 1 is a view showing a rolled material according to an embodiment of the present invention.

FIG. 2 is a view showing an exemplary foldable display apparatus.

FIG. 3 is a view showing an exemplary curvable display apparatus.

FIG. 4 is a graph showing a relation between Vickers hardness and fatigue limit.

FIG. 5 is a view illustrating a method for producing the rolled material.

FIG. 6 is a view illustrating a roll direction and a transverse direction.

FIG. 7 is a graph showing a relation between index value and bend radius.

### MODES FOR CARRYING OUT THE INVENTION

Embodiments according to the present invention will be described with reference to the drawings.

### (Configuration of Rolled Material)

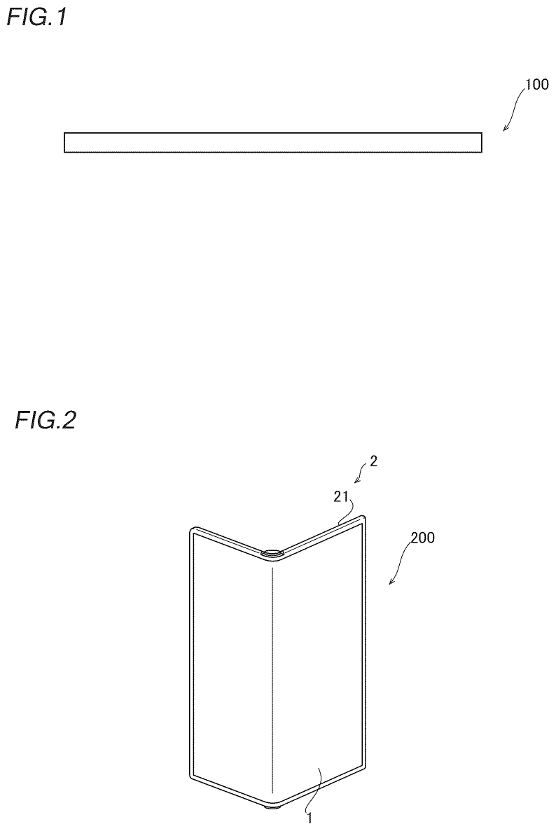

A rolled material 100 according to one embodiment is now described with reference to FIG. 1.

As shown in FIG. 1, the rolled material 100 is formed of an alloy or pure metal. The alloy is a titanium alloy, stainless steel, or a copper alloy. The pure metal is pure titanium, such as TR270C.

The titanium alloy is a beta-type titanium alloy having a body-centered cubic crystal as its three-dimensional structure. The beta titanium alloy includes at least one of vanadium (V), molybdenum (Mo), and niobium (Nb) in addition to titanium (Ti). For example, the beta-type titanium alloy includes not smaller than 14.0 mass % and not greater than 16.0 mass % of V, not smaller than 2.5 mass % and not greater than 3.5 mass % of Cr, not smaller than 2.5 mass % and not greater than 3.5 mass % of Sn and not smaller than 2.5 mass % and not greater than 3.5 mass % of Al, and an example of the beta-type titanium alloy can be provided by Ti-15V-3Cr-3Sn-3Al, which is represented in mass %, and the like.

Other examples of the beta-type titanium alloy can be provided by Ti-15Mo-5Zr, Ti-15Mo-5Zr-3Al, Ti-11.5Mo-6Zr-4.5Sn, Ti-4Mo-8V-6Cr-3Al-4Zr, Ti-13V-11Cr-3Al, Ti-29Nb-13Ta-4.6Zr, Ti-36Nb-2Ta-3Zr-0.3O, Ti-5Fe-3Nb-3Zr, and the like.

The stainless steel includes austenitic stainless steel. The stainless steel as austenitic stainless steel includes SUS301, SUS316L, and Fe-19Cr-11Mn-6Ni-0.35N-0.09C (YUS130S), which is represented in mass %. The copper alloy includes a beryllium copper alloy.

The rolled material 100 is used for a part that can elastically deform to bend or curve. A thickness of the rolled material 100 is preferably not greater than 0.03 mm, and more preferably not greater than 0.02 mm.

While internal stresses are produced in the rolled material 100 according to this embodiment by bending repetitions in elastic deformations, it is preferable that the rolled material has a larger fatigue limit from the viewpoint of increasing the number of repetitions (bending number) that reach a fracture due to the stress (fatigue failure).

In this embodiment, a value obtained by the following equation (1) is used as an index value of durability against bending repetitions. The index value is not smaller than 0.014 HV/GPa. It is preferable that the index value is not smaller than 0.019 HV/GPa. Also, the index value may be set in a range not smaller than 0.014 HV/GPa and not greater than 0.029 HV/GPa.

$$index value = ( 0.0048 \times ( Vickers hardness ) + 0.21 ) / ( modulus of elasticity ) \qquad ( 1 )$$

In this embodiment, a value obtained by the following equation (2) is used as a prediction value of a minimum bend radius to which the rolled material 100 is foldable or curvable when elastically repeatedly deforming. In the present invention, the modulus of elasticity and the Vickers hardness are adjusted to bring the prediction value of the minimum bend radius not greater than 2.14 mm in a case in which the thickness of the rolled material 100 is 0.03 mm.

$$minimum bend radius = ( thickness \times modulus of elasticity ) / ( 0.0048 \times Vickers hardness + 0.21 ) \qquad ( 2 )$$

In this embodiment, the minimum bend radius of the rolled material 100 is not greater than 2.1 mm, preferably 1.5 mm. A bending direction can be a roll direction or a transverse direction. As shown in FIG. 6, the roll direction (RD) is defined by a direction in which the rolled material 100 is rolled by a roller 11, and the transverse direction (TD) is defined by a direction perpendicular to the roll direction.

In this embodiment, it is preferable that the thickness of the rolled material is not greater than 0.03 mm, and a maximum value of a foldable or curvable bend radius of the rolled material 100 that is actually measured is not greater than 2.1 mm when the rolled material elastically deforms.

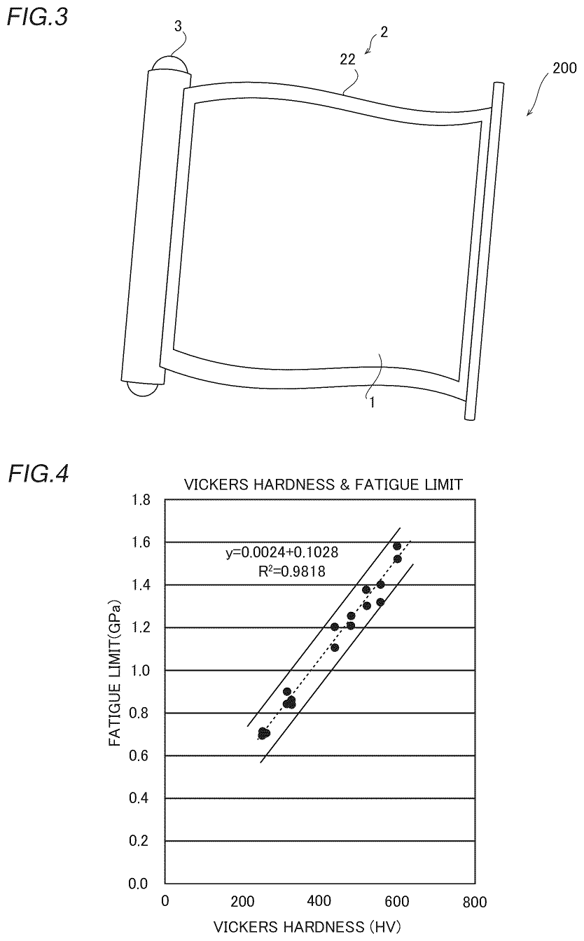

As shown in FIGS. 2 and 3, the rolled material 100 is used in a display apparatus 200 including a communication device, a television, or a computer. The display apparatus 200 includes a display 1 and a support 2 supporting the display 1. The display 1 displays images using an organic EL (Electro Luminescence). The support 2 is formed of the rolled material 100. The display apparatus 200 can elastically deform to be foldable or curvable.

As shown in FIG. 2, the display apparatus 200 that can elastically deform to be foldable includes the display 1 and the support 21 that can bend so that the display apparatus is foldable. In the display apparatus of FIG. 2, the support 21 is produced by forming the rolled material 100 into a frame shape that surrounds the display 1.

As shown in FIG. 3, the display apparatus 200 that can elastically deform to be curvable includes the display 1 and the support 22 that can curve so that the display apparatus can be wound around a shaft 3. In the display apparatus of FIG. 3, the support 22 is produced by forming the rolled material 100 into a sheet shape.

The aforementioned equations (1) and (2) are described with reference to FIG. 4. The inventor of the present application prepared a titanium alloy (rolled material) having a thickness of 0.03 mm (30 μm), set a fatigue limit in a case in which a value of surface stress of the titanium alloy (rolled material) becomes 900 MPa when the rolled material bended at a bend radius of 1.2 mm as a fatigue strength in which no fatigue failure occurs in the rolled material, and plots a relation between the fatigue limit (GPa) and the Vickers hardness (HV). As a result, the inventor has found that the relation shows proportionality between the fatigue limit and the Vickers hardness, and that a relation equation fatigue limit a σ′=(0.0024×Vickers hardness+0.1028) . . . (3) holds in the proportionality. In addition, a coefficient of determination R², which represents errors of actual measurement values in this equation (3), was 0.9818, which is close to 1, and as a result it can be said the equation is appropriate.

Here, a maximum bending stress a is represented by σ=t×E/2ρ . . . Equation (4). In the equation, t is a thickness of the rolled material 100, E is an elastic modulus of the rolled material 100, and ρ is a bend radius. The inventor of this application sets a bend radius ρ in a case in which the maximum bending stress a is equal to the fatigue limit σ′ as a minimum bend radius ρ that allows the rolled material to withstand 200,000 repetitions. The inventor then derives equation (5) of t×E/2ρ=(0.0024×Vickers hardness+0.1028) from equations (3) and (4), and derives an equation of ρ=t×E/(0.0048×Vickers hardness+0.2056) by transforming equation (5). The inventor then derives equation (2), which is a prediction equation for the minimum bending radius, by rounding off 0.2056 to the second decimal place as 0.21. Also, since durability against bending repetitions in elastic deformations increases with increase of (0.0048×Vickers hardness+0.21), and the rolled material can easily deform in a case in which the modulus of elasticity is smaller, the inventor sets (0.0048×Vickers hardness+0.21)/(modulus of elasticity) as the index value.

### (Production Method of Rolled Material)

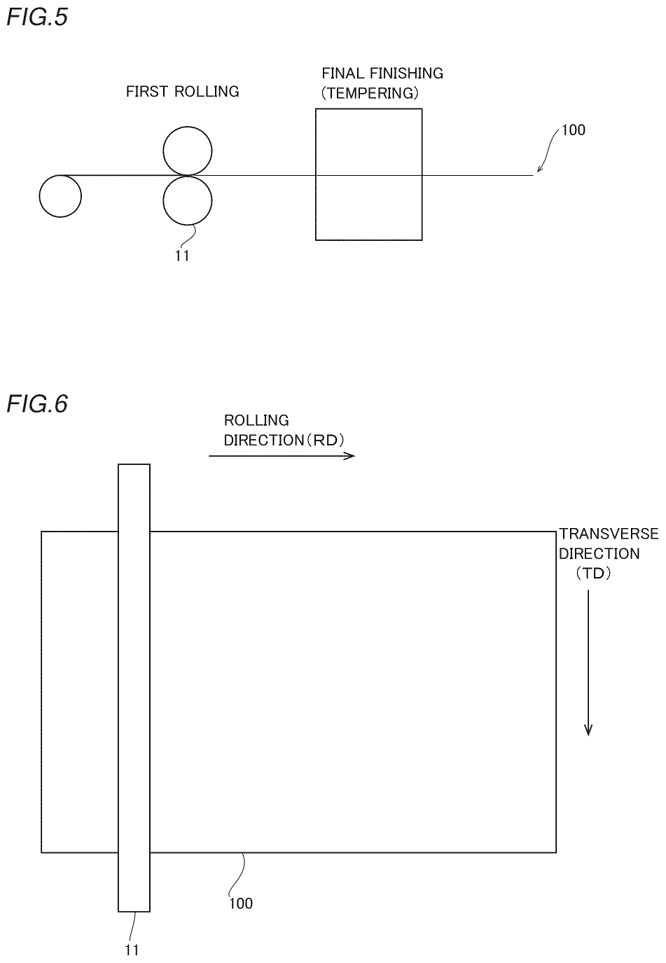

As shown in FIG. 5, the rolled material 100 is rolled by a roller 11 for applying first rolling to the alloy or pure metal, and is then adjusted to bring the index not smaller than 0.014 HV by tempering the alloy or pure metal. The tempering includes rolling and heat treatment such as annealing and aging, and any one of them may be only conducted or a combination of them may be conducted. For example, only the rolling is conducted to bring a rolling reduction ratio to not smaller than 90%. Also, the annealing may be conducted at a temperature in a range not lower than 750° C. and not higher than 850° C. for one minute. After the rolling is conducted to bring the rolling reduction ratio not smaller than 60%, heat treatment may be conducted at 450° C. for time not shorter than one minute and not longer than four hours.

### Advantages of the Embodiment

In this embodiment, the following advantages are obtained.

The rolled material 100 according to this embodiment is the rolled material 100, which is the rolled material to be used for a foldable or curvable part and includes an alloy or a pure metal, is formed of the alloy or the pure metal, wherein a value obtained by the following equation (1) is used as an index value of durability against bending repetitions, the index value of the rolled material is not smaller than 0.014 HV/GPa

$$index value = ( 0.0048 \times ( Vickers hardness ) + 0.21 ) / ( modulus of elasticity ) \qquad ( 1 )$$

Here, the inventor of the present application has found that (0.0048×(Vickers hardness)+0.21)/(modulus of elasticity) can be considered as a value of the fatigue limit. Accordingly, in a case in which this index value is not smaller than 0.014 HV/GPa, the fatigue limit becomes sufficiently large so that durability against bending repetitions in elastic deformations can be increased. Also, since the modulus of elasticity represents a magnitude of strain caused by a bending stress, reduction of the modulus of elasticity reduces the strain, and as a result it is possible to prevent a fatigue caused by bending repetitions in elastic deformations. Consequently, it is possible to provide the rolled material 100 having good durability to withstand bending stresses applied to the rolled material 100 by bending repetitions in elastic deformation.

In this embodiment, the index value of the rolled material is not smaller than 0.019 HV/GPa. The inventor of the present application has found that this configuration can provide a sufficient durability against bending repetitions in elastic deformations and can further reduce the bend radius of the rolled material based on the experiment.

In this embodiment, the pure metal is pure titanium. The inventor of the present application has found that this configuration using pure titanium can satisfy that the index value of the rolled material is not smaller than 0.014 HV/GPa.

In this embodiment, the alloy is a beta-type titanium alloy, austenitic stainless steel, or beryllium copper. The inventor of the present application has found that this configuration using the beta-type titanium alloy, austenitic stainless steel, or beryllium copper can satisfy that the index value is not smaller than 0.014 HV/GPa and bring the bend radius not greater than 3 mm.

In this embodiment, the beta-type titanium alloy comprises not smaller than 14.0 mass % and not greater than 16.0 mass % of V, not smaller than 2.5 mass % and not greater than 3.5 mass % of Cr, not smaller than 2.5 mass % and not greater than 3.5 mass % of Sn, and not smaller than 2.5 mass % and not greater than 3.5 mass % of Al. The inventor of the present application has found that this configuration can satisfy that the index value of the rolled material is not smaller than 0.014 HV/GPa and bring the bend radius of the rolled material having a thickness of 0.03 mm not greater than 3 mm.

In this embodiment, a value is obtained by the following equation (2) and is used as a prediction value of a minimum bend radius to which the rolled material is foldable or curvable, and the prediction value of the minimum bend radius of the rolled material whose thickness is 0.03 mm is not greater than 2.14 mm,

minimum bend radius=(thickness×modulus of elasticity)/(0.0048×Vickers hardness+0.21) (2)

According to this configuration, the bend radius can be reduced by adjusting the modulus of elasticity or Vickers hardness to bring the prediction value of the minimum bend radius not greater than 2.14 mm. Also, since prediction of the minimum bend radius can obtain a value of the minimum bend radius to which the rolled material 100 can be considered to be folded or curved by elastic deformation without conducting experiments, it is possible to easily design the desired rolled material 100.

In this embodiment, the rolled material 100 is used for a foldable or curvable support 2 supporting the display 1 of the display apparatus 200. According to this configuration, it is possible to improve durability against bending repetitions of the support 2, which is repeatedly folded or curved in elastic deformation when the display 1 is repeatedly bent and deformed in elastic deformation.

In this embodiment, the rolled material has a thickness not greater than 0.03 mm, and a maximum value of a foldable or curvable bend radius of the rolled material that is actually measured is not greater than 2.1 mm. According to this configuration, since the thickness of the rolled material 100 can be sufficiently small and the bend radius can be sufficiently small, it is possible to use the rolled material 100 for foldable or curvable portable devices.

In this embodiment, the index value of the rolled material is not smaller than 0.014 HV/GPa and not greater than 0.029 HV/GPa. The inventor of the present application has found that the bend radius in elastic deformation can be sufficiently reduced by bringing the index value within this range.

### EXAMPLES

The following description describes a comparative experiment (between examples and comparative examples) in the aforementioned embodiment.

As shown in Table 1, index values of durability against bending repetitions in elastic deformations of examples 1 to 27 and comparative examples 1 to 4 are calculated by using Vickers hardnesses and moduli of elasticity.

TABLE 1

| | | | | | | Measurement | |
|---|---|---|---|---|---|---|---|
| | | | Vickers | Elastic | | Direction of | |
| | Roll Material Composition | Finish | hardness | Modulus | Index | Elastic | |
| No. | (% Mass) | Symbol | (HV) | (GPa) | (HV/GPa) | Modulus | Final Finish (Tempering) |
| Ex. 1 | Ti—15V—3Cr—3Sn—3Al | H | 316 | 72 | 0.0240 | RD | Rolling (Reduction Ratio 95%) |
| Ex. 2 | Ti—15V—3Cr—3Sn—3Al | H | 316 | 90 | 0.0192 | TD | Rolling (Reduction Ratio 95%) |
| Ex. 3 | Ti—15V—3Cr—3Sn—3Al | H | 326 | 69 | 0.0257 | RD | Rolling (Reduction Ratio 97%) |
| Ex. 4 | Ti—15V—3Cr—3Sn—3Al | H | 326 | 84 | 0.0211 | TD | Rolling (Reduction Ratio 97%) |
| Ex. 5 | Ti—15V—3Cr—3Sn—3Al | HT | 480 | 109 | 0.0231 | RD | Aging (450° C. for 4 hrs) |
| | | | | | | | After Rolling (Reduction Ratio 95%) |
| Ex. 6 | Ti—15V—3Cr—3Sn—3Al | HT | 480 | 121 | 0.0208 | TD | Aging (450° C. for 4 hrs) |
| | | | | | | | After Rolling (Reduction Ratio 95%) |
| Ex. 7 | Ti—15V—3Cr—3Sn—3Al | O | 262 | 80 | 0.0183 | RD | Annealing (800° C. for 1 min.) |
| Ex. 8 | Ti—15V—3Cr—3Sn—3Al | O | 262 | 94 | 0.0156 | TD | Annealing (800° C. for 1 min.) |
| Ex. 9 | Ti—15Mo—5Zr | O | 280 | 78 | 0.0199 | RD | Annealing (850° C. for 1 min.) |
| Ex. 10 | Ti—15Mo—5Zr—3Al | O | 275 | 100 | 0.0153 | RD | Annealing (850° C. for 1 min.) |

Table 1 provides a listing of the examples 1 to 10. Rolled materials 100 according to the examples 1 to 10 were formed of beta-type titanium alloys.

Specifically, as shown in Table 1, the rolled materials according to the examples 1 to 8 were formed of Ti-15V-3Cr-3Sn-3Al in mass %. The rolled material according to the example 9 was formed of Ti-15Mo-5Zr in mass %. The rolled material according to the example 10 was formed of Ti-15Mo-5Zr-3Al in mass %.

Also, H is a finishing symbol indicating that the final finishing (tempering) was cold rolling (second rolling process) in the examples 1 to 10. O is a finishing symbol indicating that the final finishing (tempering) was annealing. HT is a finishing symbol indicating that heat treatment (e.g., aging with leaving time for longer than one hour) was conducted after rolling in the final finishing (tempering).

The rolled material (thickness of 0.03 mm, finishing symbol: H) according to the example 1 was formed of Ti-15V-3Cr-3Sn-3Al, and was then subjected to tempering (rolled at a rolling reduction ratio of 95%). A measured modulus of elasticity in the roll direction (rolling direction) in the example 1 was 72 GPa. A Vickers hardness in the example 1 was 316 HV. Accordingly, an index value of the example 1 is 0.0240 HV/GPa.

The rolled material (thickness of 0.03 mm, finishing symbol: H) according to the example 2 was formed of Ti-15V-3Cr-3Sn-3Al, and was then subjected to tempering (rolled at a rolling reduction ratio of 95%). A measured modulus of elasticity in the transverse direction (perpendicular to the rolling direction) in the example 2 was 90 GPa. A Vickers hardness in the example 2 was 316 HV. Accordingly, an index value of the example 2 is 0.0192 HV/GPa.

The rolled material (thickness of 0.02 mm, finishing symbol: H) according to the example 3 was formed of Ti-15V-3Cr-3Sn-3Al, and was then subjected to tempering (rolled at a rolling reduction ratio of 97%). A measured modulus of elasticity in the roll direction (rolling direction) in the example 3 was 69 GPa. A Vickers hardness in the example 3 was 326 HV. Accordingly, an index value of the example 3 is 0.0257 HV/GPa.

The rolled material (thickness of 0.02 mm, finishing symbol: H) according to the example 4 was formed of Ti-15V-3Cr-3Sn-3Al, and was then subjected to tempering (rolled at a rolling reduction ratio of 97%). A measured modulus of elasticity in the transverse direction (perpendicular to the rolling direction) in the example 4 was 84 GPa. A Vickers hardness in the example 4 was 326 HV. Accordingly, an index value of the example 4 is 0.0211 HV/GPa.

The rolled material (thickness of 0.03 mm, finishing symbol: HT) according to the example 5 was formed of Ti-15V-3Cr-3Sn-3Al, and was then subjected to tempering. The rolled material according to the example 5 was subjected to aging with leaving time for four hours at 450° C. after rolled at a rolling reduction ratio of 95% as tempering. A measured modulus of elasticity in the roll direction (rolling direction) in the example 5 was 109 GPa. A Vickers hardness in the example 5 was 480 HV. Accordingly, an index value of the example 5 is 0.0231 HV/GPa.

The rolled material (thickness of 0.03 mm, finishing symbol: HT) according to the example 6 was formed of Ti-15V-3Cr-3Sn-3Al, and was then subjected to tempering. The rolled material according to the example 6 was subjected to aging with leaving time for four hours at 450° C. after rolled at a rolling reduction ratio of 95% as tempering. A measured modulus of elasticity in the transverse direction (perpendicular to the rolling direction) in the example 6 was 121 GPa. A Vickers hardness in the example 6 was 480 HV. Accordingly, an index value of the example 6 is 0.0208 HV/GPa.

The rolled material (thickness of 0.03 mm, finishing symbol: O) according to the example 7 was formed of Ti-15V-3Cr-3Sn-3Al, and was then subjected to annealing (left at 800° C. for one minute). A measured modulus of elasticity in the roll direction (rolling direction) in the example 7 was 80 GPa. A Vickers hardness in the example 7 was 262 HV. Accordingly, an index value of the example 7 is 0.0183 HV/GPa.

The rolled material (thickness of 0.03 mm, finishing symbol: O) according to the example 8 was formed of Ti-15V-3Cr-3Sn-3Al, and was then subjected to annealing (left at 800° C. for one minute). A measured modulus of elasticity in the transverse direction (perpendicular to the rolling direction) in the example 8 was 94 GPa. A Vickers hardness in the example 8 was 262 HV. Accordingly, an index value of the example 8 is 0.0156 HV/GPa.

The rolled material (finishing symbol: O) according to the example 9 was formed of Ti-15Mo-5Zr, and was then subjected to annealing (left at 850° C. for one minute). A modulus of elasticity in the roll direction (rolling direction) and a Vickers hardness of the rolled material in the example 9 were 78 GPa and 280 HV, respectively. Accordingly, an index value of the example 9 is 0.0199 HV/GPa.

The rolled material (finishing symbol: O) according to the example 10 was formed of Ti-15Mo-5Zr-3Al, and was then subjected to annealing (left at 850° C. for one minute). A modulus of elasticity in the roll direction (rolling direction) and a Vickers hardness of the rolled material in the example 10 were 100 GPa and 275 HV, respectively. Accordingly, an index value of the example 10 is 0.0153 HV/GPa.

TABLE 2

| | | | | | | Measurement | |
|---|---|---|---|---|---|---|---|
| | | | Vickers | Elastic | | Direction of | |
| | Roll Material Composition | Finish | Hardness | Modulus | Index | Elastic | |
| No. | (% Mass) | Symbol | (HV) | (GPa) | (HV/GPa) | Modulus | Final Finish (Tempering) |
| Ex. 11 | Ti—11.5Mo—6Zr—4.5Sn | O | 240 | 79 | 0.0172 | RD | Annealing (850° C. for 1 min.) |
| Ex. 12 | Ti—4Mo—8V—6Cr—3Al—4Zr | O | 367 | 104 | 0.0190 | RD | Annealing (750° C. for 1 min.) |
| Ex. 13 | Ti—13V—11Cr—3Al | O | 300 | 101 | 0.0163 | RD | Annealing (800° C. for 1 min.) |
| Ex. 14 | Ti—29Nb—13Ta—4.6Zr | O | 280 | 60 | 0.0259 | RD | Annealing (800° C. for 1 min.) |
| Ex. 15 | Ti—36Nb—2Ta—3Zr—0.3O | H | 313 | 75 | 0.0228 | RD | Rolling (Reduction Ratio 95%) |
| Ex. 16 | Ti—36Nb—2Ta—3Zr—0.3O | O | 250 | 50 | 0.0282 | RD | Annealing (850° C. for 1 min.) |
| Ex. 17 | Ti—5Fe—3Nb—3Zr | O | 375 | 82 | 0.0245 | RD | Annealing (900° C. for 1 min.) |
| Ex. 18 | TR270C | H | 251 | 93 | 0.0152 | RD | Rolling (Reduction Ratio 94%) |
| Ex. 19 | TR270C | H | 251 | 95 | 0.0149 | TD | Rolling (Reduction Ratio 94%) |
| Ex. 20 | TR550C | H | 300 | 105 | 0.0157 | RD | Rolling (Reduction Ratio 65%) |

Table 2 provides a listing of the examples 11 to 20. Rolled materials 100 according to the examples 11 to 17 were formed of beta-type titanium alloys. Also, rolled materials 100 according to the examples 18 to 20 were formed of pure Ti.

Specifically, as shown in Table 2, the rolled materials according to the example 11 was formed of Ti-11.5Mo-6Zr-4.5Sn in mass %. The rolled material according to the example 12 was formed of Ti-4Mo-8V-6Cr-3Al-4Zr in mass %. The rolled material according to the example 13 was formed of Ti-13V-11Cr-3Al in mass %. The rolled material according to the example 14 was formed of Ti-29Nb-13Ta-4.6Zr in mass %. The rolled materials according to the examples 15 and 16 were formed of Ti-36Nb-2Ta-3Zr-0.3O in mass %. The rolled material according to the example 17 was formed of Ti-5Fe-3Nb-3Zr in mass %. The rolled materials according to the examples 18 and 19 were formed of TR270C (JIS H4600:2012). The rolled material according to the example 20 was formed of TR550C (JIS H4600:2012).

Also, H is a finishing symbol indicating that the final finishing (tempering) was cold rolling (second rolling process) in the examples 11 to 20. O is a finishing symbol indicating that the final finishing (tempering) was annealing.

The rolled material (finishing symbol: O) according to the example 11 was formed of Ti-11.5Mo-6Zr-4.5Sn, and was then subjected to annealing (left at 850° C. for one minute). A modulus of elasticity in the roll direction (rolling direction) and a Vickers hardness of the rolled material in the example 11 were 79 GPa and 240 HV, respectively. Accordingly, an index value of the example 11 is 0.0172 HV/GPa.

The rolled material (finishing symbol: O) according to the example 12 was formed of Ti-4Mo-8V-6Cr-3Al-4Zr, and was then subjected to annealing (left at 750° C. for one minute). A modulus of elasticity in the roll direction (rolling direction) and a Vickers hardness of the rolled material in the example 12 were 104 GPa and 367 HV, respectively. Accordingly, an index value of the example 12 is 0.0190 HV/GPa.

The rolled material (finishing symbol: O) according to the example 13 was formed of Ti-13V-11Cr-3Al, and was then subjected to annealing (left at 800° C. for one minute). A modulus of elasticity in the roll direction (rolling direction) and a Vickers hardness of the rolled material in the example 13 were 101 GPa and 300 HV, respectively. Accordingly, an index value of the example 13 is 0.0163 HV/GPa.

The rolled material (finishing symbol: O) according to the example 14 was formed of Ti-29Nb-13Ta-4.6Zr, and was then subjected to annealing (left at 800° C. for one minute). A modulus of elasticity in the roll direction (rolling direction) and a Vickers hardness of the rolled material in the example 14 were 60 GPa and 280 HV, respectively. Accordingly, an index value of the example 14 is 0.0259 HV/GPa.

The rolled material (thickness of 0.10 mm, finishing symbol: H) according to the example 15 was formed of Ti-36Nb-2Ta-3Zr-0.3O, and was then subjected to tempering (rolled at a rolling reduction ratio of 95%). A measured modulus of elasticity in the roll direction (rolling direction) in the example 15 was 75 GPa. A Vickers hardness in the example 15 was 313 HV. Accordingly, an index value of the example 15 is 0.0228 HV/GPa.

The rolled material (finishing symbol: O) according to the example 16 was formed of Ti-36Nb-2Ta-3Zr-0.3O, and was then subjected to annealing (left at 850° C. for one minute). A modulus of elasticity in the roll direction (rolling direction) and a Vickers hardness of the rolled material in the example 16 were 50 GPa and 250 HV, respectively. Accordingly, an index value of the example 16 is 0.0282 HV/GPa.

The rolled material (finishing symbol: O) according to the example 17 was formed of Ti-5Fe-3Nb-3Zr, and was then subjected to annealing (left at 900° C. for one minute). A modulus of elasticity in the roll direction (rolling direction) and a Vickers hardness of the rolled material in the example 17 were 82 GPa and 375 HV, respectively. Accordingly, an index value of the example 17 is 0.0245 HV/GPa.

The rolled material (thickness of 0.03 mm, finishing symbol: H) according to the example 18 was formed of TR270C (JIS H4600:2012), and was then subjected to tempering (rolled at a rolling reduction ratio of 94%). A measured modulus of elasticity in the roll direction (rolling direction) in the example 18 was 93 GPa. A Vickers hardness in the example 18 was 251 HV. Accordingly, an index value of the example 18 is 0.0152 HV/GPa.

The rolled material (thickness of 0.03 mm, finishing symbol: H) according to the example 19 was formed of TR270C (JIS H4600:2012), and was then subjected to tempering (rolled at a rolling reduction ratio of 94%). A measured modulus of elasticity in the transverse direction (perpendicular to the rolling direction) in the example 19 was 95 GPa. A Vickers hardness in the example 19 was 251 HV. Accordingly, an index value of the example 19 is 0.0149 HV/GPa.

The rolled material (thickness of 0.10 mm, finishing symbol: H) according to the example 20 was formed of TR550C (JIS H4600:2012), and was then subjected to tempering (rolled at a rolling reduction ratio of 65%). A measured modulus of elasticity in the roll direction (rolling direction) in the example 20 was 105 GPa. A Vickers hardness in the example 20 was 300 HV. Accordingly, an index value of the example 20 is 0.0157 HV/GPa.

TABLE 3

| | | | | | | Measurement | |
|---|---|---|---|---|---|---|---|
| | | | Vickers | Elastic | | Direction of | |
| | Roll Material Composition | Finish | Hardness | Modulus | Index | Elastic | Final Finish |
| No. | (% Mass) | Symbol | (HV) | (GPa) | (HV/GPa) | Modulus | (Tempering) |
| Ex. 21 | SUS301 | EH—TA | 600 | 183 | 0.0169 | RD | Aging (450° C. |
| | | | | | | | for 1 min.) |
| | | | | | | | After Rolling |
| | | | | | | | (Reduction Ratio 69%) |
| Ex. 22 | SUS301 | EH—TA | 600 | 211 | 0.0146 | TD | Aging (450° C. |
| | | | | | | | for 1 min.) |
| | | | | | | | After Rolling |
| | | | | | | | (Reduction Ratio 69%) |
| Ex. 23 | SUS301 | EH—TA | 557 | 182 | 0.0158 | RD | Aging (450° C. |
| | | | | | | | for 1 min.) |
| | | | | | | | After Rolling |
| | | | | | | | (Reduction Ratio 62%) |
| Ex. 24 | SUS316L | H | 438 | 155 | 0.0149 | RD | Rolling (Reduction |
| | | | | | | | Ratio 67%) |
| Ex. 25 | YUS130S | H | 520 | 174 | 0.0156 | RD | Rolling (Reduction |
| | (Fe—19Cr—11Mn—6Ni—0.35N—0.09C) | | | | | | Ratio 67%) |
| Ex. 26 | YUS130S | H | 520 | 193 | 0.0140 | TD | Rolling (Reduction |
| | (Fe—19Cr—11Mn—6Ni—0.35N—0.09C) | | | | | | Ratio 67%) |
| Ex. 27 | C1720 | XHMS | 380 | 127 | 0.0160 | RD | Aging (450° C. |
| | | | | | | | for 2 min.) |
| | | | | | | | After Rolling |
| | | | | | | | (Reduction Ratio 88%) |
| Comp. Ex. 1 | TR550C | O | 230 | 105 | 0.0125 | RD | Annealing (800° C. |
| | | | | | | | for 1 min.) |
| Comp. Ex. 2 | SUS301 | EH—TA | 557 | 211 | 0.0137 | TD | Aging (450° C. |
| | | | | | | | for 1 min.) After |
| | | | | | | | Rolling (Reduction |
| | | | | | | | Ratio 62%) |
| Comp. Ex. 3 | SUS316L | H | 438 | 185 | 0.0125 | TD | Rolling (Reduction |
| | | | | | | | Ratio 67%) |
| Comp. Ex. 4 | A5052 | H | 120 | 68 | 0.0116 | RD | Rolling (Reduction |
| | | | | | | | Ratio 90%) |

Table 3 provides a listing of the examples 21 to 27, and the comparative examples 1 to 4. Rolled materials 100 according to the examples 21 to 26 were formed of stainless steel. Also, a rolled material 100 according to the example 27 was formed of a beryllium copper alloy. Also, rolled materials according to the comparative example 1 was formed of pure Ti. Also, rolled materials according to the comparative examples 2 and 3 were formed of stainless steel. Also, a rolled material according to the comparative example 4 was formed of an aluminum alloy.

Specifically, as shown in Table 3, the rolled materials according to the examples 21 to 23 were formed of SUS301 (JIS G4313:2011). The rolled material according to the example 24 was formed of SUS316L (JIS G4305:2011). The rolled materials according to the examples 25 and 26 were formed of YUS130S (Fe-19Cr-11Mn-6Ni-0.35N-0.09C in mass %). The rolled material according to the example 27 was formed of C1720 (JIS H3130:2018). The rolled material according to the comparative example 1 was formed of TR550C (JIS H46400:2012). The rolled material according to the comparative example 2 was formed of SUS301 (JIS G4313:2011). The rolled material according to the comparative example 3 was formed of SUS316L (JIS G4305:2011). The rolled material according to the comparative example 4 was formed of A5052 (JIS H4000:2014).

Also, H is a finishing symbol indicating that the final finishing (tempering) was cold rolling (second rolling process) in the examples 21 to 26 and the comparative examples 1 to 4. O is a finishing symbol indicating that the final finishing (tempering) was annealing. EH-TA is a finishing symbol indicating that heat treatment (e.g., aging with leaving time for not longer than one hour) was conducted after rolling in the final finishing (tempering). Also, XHMS is a finishing symbol indicating that hardening treatment by causing precipitation of beryllium at a low temperature was conducted in the final finishing (tempering) in the example 27.

The rolled material (thickness of 0.03 mm, finishing symbol: EH-TA) according to the example 21 was formed of SUS301 (JIS G4313:2011), and was then subjected to tempering. The rolled material according to the example 21 was subjected to aging with leaving time for one minute at 450° C. after rolled at a rolling reduction ratio of 69% as tempering. A measured modulus of elasticity in the roll direction (rolling direction) in the example 21 was 183 GPa. A Vickers hardness in the example 21 was 600 HV. Accordingly, an index value of the example 21 is 0.0169 HV/GPa.

The rolled material (thickness of 0.03 mm, finishing symbol: EH-TA) according to the example 22 was formed of SUS301 (JIS G4313:2011), and was then subjected to tempering. The rolled material according to the example 22 was subjected to aging with leaving time for one minute at 450° C. after rolled at a rolling reduction ratio of 69% as tempering. A measured modulus of elasticity in the transverse direction (perpendicular to the rolling direction) in the example 22 was 211 GPa. A Vickers hardness in the example 22 was 600 HV. Accordingly, an index value of the example 22 is 0.0146 HV/GPa.

The rolled material (thickness of 0.02 mm, finishing symbol: EH-TA) according to the example 23 was formed of SUS301 (JIS G4313:2011), and was then subjected to tempering. The rolled material according to the example 23 was subjected to aging with leaving time for one minute at 450° C. after rolled at a rolling reduction ratio of 62% as tempering. A measured modulus of elasticity in the roll direction (rolling direction) in the example 23 was 182 GPa. A Vickers hardness in the example 23 was 557 HV. Accordingly, an index value of the example 23 is 0.0158 HV/GPa.

The rolled material (thickness of 0.03 mm, finishing symbol: H) according to the example 24 was formed of SUS316L (JIS G4305:2021), and was then subjected to tempering (rolled at a rolling reduction ratio of 67%). A measured modulus of elasticity in the roll direction (rolling direction) in the example 24 was 155 GPa. A Vickers hardness in the example 24 was 438 HV. Accordingly, an index value of the example 24 is 0.0149 HV/GPa.

The rolled material (thickness of 0.03 mm, finishing symbol: H) according to the example 25 was formed of YUS130S (Fe-19Cr-11Mn-6Ni-0.35N-0.09C), and was then subjected to tempering (rolled at a rolling reduction ratio of 67%). A measured modulus of elasticity in the roll direction (rolling direction) in the example 25 was 174 GPa. A Vickers hardness in the example 25 was 520 HV. Accordingly, an index value of the example 25 is 0.0156 HV/GPa.

The rolled material (thickness of 0.03 mm, finishing symbol: H) according to the example 26 was formed of YUS130S (Fe-19Cr-11Mn-6Ni-0.35N-0.09C), and was then subjected to tempering (rolled at a rolling reduction ratio of 67%). A measured modulus of elasticity in the transverse direction (perpendicular to the rolling direction) in the example 26 was 193 GPa. A Vickers hardness in the example 26 was 520 HV. Accordingly, an index value of the example 26 is 0.0140 HV/GPa.

The rolled material (thickness of 0.03 mm, finishing symbol: XHMS) according to the example 27 was formed of C1720 (JIS H3130:2018), and was then subjected to tempering. The rolled material according to the example 27 was subjected to annealing with leaving time for two minutes at 450° C. after rolled at a rolling reduction ratio of 88% as tempering. A measured modulus of elasticity in the roll direction (rolling direction) in the example 27 was 127 GPa. A Vickers hardness in the example 27 was 380 HV. Accordingly, an index value of the example 27 is 0.0160 HV/GPa.

The rolled material (thickness of 0.10 mm, finishing symbol: O) according to the comparative example 1 was formed of TR550C (JIS H4600:2012), and was then subjected to annealing (left at 800° C. for one minute). A measured modulus of elasticity in the roll direction (rolling direction) in the comparative example 1 was 105 GPa. A Vickers hardness in the comparative example 1 was 230 HV. Accordingly, an index value of the comparative example 1 is 0.0125 HV/GPa.

The rolled material (thickness of 0.02 mm, finishing symbol: EH-TA) according to the comparative example 2 was formed of SUS301 (JIS H4313:2011), and was then subjected to tempering. The rolled material according to the comparative example 2 was subjected to aging with leaving time for one minute at 450° C. after rolled at a rolling reduction ratio of 62% as tempering. A measured modulus of elasticity in the transverse direction (perpendicular to the rolling direction) in the comparative example 2 was 211 GPa. A Vickers hardness in the comparative example 2 was 557 HV. Accordingly, an index value of the comparative example 2 is 0.0137 HV/GPa.

The rolled material (thickness of 0.03 mm, finishing symbol: H) according to the comparative example 3 was formed of SUS316L (JIS H4305:2021), and was then subjected to tempering (rolled at a rolling reduction ratio of 67%). A measured modulus of elasticity in the transverse direction (perpendicular to the rolling direction) in the comparative example 3 was 185 GPa. A Vickers hardness in the comparative example 3 was 438 HV. Accordingly, an index value of the comparative example 3 is 0.0125 HV/GPa.

The rolled material (thickness of 0.03 mm, finishing symbol: H) according to the comparative example 4 was formed of A5052 (JIS H4000:2014), and was then subjected to tempering (rolled at a rolling reduction ratio of 90%). A measured modulus of elasticity in the roll direction (rolling direction) in the comparative example 4 was 68 GPa. A Vickers hardness in the comparative example 4 was 120 HV. Accordingly, an index value of the comparative example 4 is 0.0116 HV/GPa.

The inventor of the present application has found that from the aforementioned results, even if rolled materials are formed of the same chemical components, index values become different in some cases and do not satisfy the target value when final finishing treatments (tempering conditions, and the like) or directions of measurement of moduli of elasticity are different.

Table 4 provides a listing of prediction values of minimum bend radii that allow the rolled materials 100 according to the examples 1 to 8, 18, 19 and 21 to withstand 200,000 bending repetitions, and their actual measurement values of the minimum bend radii, which allow the rolled materials to withstand 200,000 bending repetitions. Here, the 200,000 bending repetitions are bending repetitions in elastic deformations. Also, the prediction values of the minimum bend radii, which allow the rolled materials to withstand 200,000 bending repetitions, are obtained by using the equation of minimum bend radius (R)=(thickness×modulus of elasticity)/(0.0048×Vickers hardness+0.21). Also, the actual measurement values of the minimum bend radii that allow the rolled materials to withstand 200,000 bending repetitions were acquired by adding 0.1 mm to bend radii that prevented the rolled materials from withstanding 200,000 bending repetitions when bend radii of the rolled materials 100 were actually reduced by 0.1 mm from 3.0 mm as the actual measurement values of the minimum bend radii, which allow the rolled materials to withstand 200,000 bending repetitions.

TABLE 4

| | | | Thickness of | | Predicted | Actual Min. | |
|---|---|---|---|---|---|---|---|
| | Roll Material Composition | Finish | Rolled | Index | Min. Bend | Bend Rad. | Bend |
| No. | (% Mass) | Symbol | Material (mm) | (HV/GPa) | Rad. (mm) | (mm) | Direction |
| Ex. 1 | Ti—15V—3Cr—3Sn—3Al | H | 0.03 | 0.0240 | 1.25 | 1.20 | RD |
| Ex. 2 | Ti—15V—3Cr—3Sn—3Al | H | 0.03 | 0.0192 | 1.56 | 1.60 | TD |
| Ex. 3 | Ti—15V—3Cr—3Sn—3Al | H | 0.02 | 0.0257 | 0.78 | 0.80 | RD |
| Ex. 4 | Ti—15V—3Cr—3Sn—3Al | H | 0.02 | 0.0211 | 0.95 | 1.00 | TD |
| Ex. 5 | Ti—15V—3Cr—3Sn—3Al | HT | 0.03 | 0.0231 | 1.30 | 1.30 | RD |
| Ex. 6 | Ti—15V—3Cr—3Sn—3Al | HT | 0.03 | 0.0208 | 1.44 | 1.50 | TD |
| Ex. 7 | Ti—15V—3Cr—3Sn—3Al | O | 0.03 | 0.0183 | 1.64 | 1.70 | RD |
| Ex. 8 | Ti—15V—3Cr—3Sn—3Al | O | 0.03 | 0.0156 | 1.92 | 2.00 | TD |
| Ex. 18 | TR270C | H | 0.03 | 0.0152 | 1.97 | 2.00 | RD |
| Ex. 19 | TR270C | H | 0.03 | 0.0149 | 2.01 | 2.00 | TD |
| Ex. 21 | SUS301 | EH—TA | 0.03 | 0.0169 | 1.78 | 1.80 | RD |

The prediction value of the minimum bend radius, which allows the rolled material to withstand 200,000 bending repetitions, in the example 1 is 1.25 mm when the rolled material is repeatedly bent in the roll direction (rolling direction). The actual measurement value corresponding to this prediction value was 1.20 mm.

The prediction value of the minimum bend radius, which allows the rolled material to withstand 200,000 bending repetitions, in the example 2 is 1.56 mm when the rolled material is repeatedly bent in the transverse direction (the direction perpendicular to the rolling direction). The actual measurement value corresponding to this prediction value was 1.60 mm.

The prediction value of the minimum bend radius, which allows the rolled material to withstand 200,000 bending repetitions, in the example 3 is 0.78 mm when the rolled material is repeatedly bent in the roll direction (rolling direction). The actual measurement value corresponding to this prediction value was 0.80 mm.

The prediction value of the minimum bend radius, which allows the rolled material to withstand 200,000 bending repetitions, in the example 4 is 0.95 mm when the rolled material is repeatedly bent in the transverse direction (the direction perpendicular to the rolling direction). The actual measurement value corresponding to this prediction value was 1.00 mm.

The prediction value of the minimum bend radius, which allows the rolled material to withstand 200,000 bending repetitions, in the example 5 is 1.30 mm when the rolled material is repeatedly bent in the roll direction (rolling direction). The actual measurement value corresponding to this prediction value was 1.30 mm.

The prediction value of the minimum bend radius, which allows the rolled material to withstand 200,000 bending repetitions, in the example 6 is 1.44 mm when the rolled material is repeatedly bent in the transverse direction (the direction perpendicular to the rolling direction). The actual measurement value corresponding to this prediction value was 1.50 mm.

The prediction value of the minimum bend radius, which allows the rolled material to withstand 200,000 bending repetitions, in the example 7 is 1.64 mm when the rolled material is repeatedly bent in the roll direction (rolling direction). The actual measurement value corresponding to this prediction value was 1.70 mm.

The prediction value of the minimum bend radius, which allows the rolled material to withstand 200,000 bending repetitions, in the example 8 is 1.92 mm when the rolled material is repeatedly bent in the transverse direction (the direction perpendicular to the rolling direction). The actual measurement value corresponding to this prediction value was 2.00 mm.

The prediction value of the minimum bend radius, which allows the rolled material to withstand 200,000 bending repetitions, in the example 18 is 1.97 mm when the rolled material is repeatedly bent in the roll direction (rolling direction). In this case, the actual measurement value was 2.00 mm.

The prediction value of the minimum bend radius, which allows the rolled material to withstand 200,000 bending repetitions, in the example 19 is 2.01 mm when the rolled material is repeatedly bent in the transverse direction (the direction perpendicular to the rolling direction). The actual measurement value corresponding to this prediction value was 2.00 mm.

The prediction value of the minimum bend radius, which allows the rolled material to withstand 200,000 bending repetitions, in the example 21 is 1.78 mm when the rolled material is repeatedly bent in the roll direction (rolling direction). The actual measurement value corresponding to this prediction value was 1.80 mm.

Table 5 provides a listing of prediction values of minimum bend radii that allow the rolled materials 100 according to the examples 22 to 26, and the comparative examples 2 and 3 to withstand 200,000 bending repetitions, and their actual measurement values of the minimum bend radii, which allow the rolled materials to withstand 200,000 bending repetitions. Here, the 200,000 bending repetitions are bending repetitions in elastic deformations. Also, the prediction values of the minimum bend radii, which allow the rolled materials to withstand 200,000 bending repetitions, are obtained by using the equation of minimum bend radius (R)=(thickness×modulus of elasticity)/(0.0048×Vickers hardness+0.21). Also, the actual measurement values of the minimum bend radii that allow the rolled materials to withstand 200,000 bending repetitions were acquired by adding 0.1 mm to bend radii that prevented the rolled materials from withstanding 200,000 bending repetitions when bend radii of the rolled materials 100 were actually reduced by 0.1 mm from 3.0 mm, as the actual measurement values of the minimum bend radii, which allow the rolled materials to withstand 200,000 bending repetitions.

TABLE 5

| | | | Thickness | | Predicted | Actual Min. | |
|---|---|---|---|---|---|---|---|
| | Rolled Material Composition | Finish | of Rolled | Index | Min. Bend | Bend Rad. | Bend |
| No. | (% mass) | Symbol | Mat. (mm) | (HV/GPa) | Rad. (mm) | (mm) | Direction |
| Ex. 22 | SUS301 | EH—TA | 0.03 | 0.0146 | 2.05 | 2.00 | TD |
| Ex. 23 | SUS301 | EH—TA | 0.02 | 0.0158 | 1.26 | 1.30 | RD |
| Ex. 24 | SUS316L | H | 0.03 | 0.0149 | 2.01 | 2.10 | RD |
| Ex. 25 | YUS130S | H | 0.03 | 0.0156 | 1.93 | 2.00 | RD |
| | (Fe—19Cr—11Mn—6Ni—0.35N—0.09C) | | | | | | |
| Ex. 26 | YUS130S | H | 0.03 | 0.0140 | 2.14 | 2.10 | TD |
| | (Fe—19Cr—11Mn—6Ni—0.35N—0.09C) | | | | | | |
| Comp. Ex. 2 | SUS301 | EH—TA | 0.02 | 0.0137 | 1.46 | 1.60 | TD |
| Comp. Ex. 3 | SUS316L | H | 0.03 | 0.0125 | 2.40 | 2.30 | TD |

The prediction value of the minimum bend radius, which allows the rolled material to withstand 200,000 bending repetitions, in the example 22 is 2.05 mm when the rolled material is repeatedly bent in the transverse direction (the direction perpendicular to the rolling direction), and the actual measurement value corresponding to this prediction value was 2.00 mm.

The prediction value of the minimum bend radius, which allows the rolled material to withstand 200,000 bending repetitions, in the example 23 is 1.26 mm when the rolled material is repeatedly bent in the roll direction (rolling direction). The actual measurement value corresponding to this prediction value was 1.30 mm.

The prediction value of the minimum bend radius, which allows the rolled material to withstand 200,000 bending repetitions, in the example 24 is 2.01 mm when the rolled material is repeatedly bent in the roll direction (rolling direction). The actual measurement value corresponding to this prediction value was 2.10 mm.

The prediction value of the minimum bend radius, which allows the rolled material to withstand 200,000 bending repetitions, in the example 25 is 1.93 mm when the rolled material is repeatedly bent in the roll direction (rolling direction). The actual measurement value corresponding to this prediction value was 2.00 mm.

The prediction value of the minimum bend radius, which allows the rolled material to withstand 200,000 bending repetitions, in the example 26 is 2.14 mm when the rolled material is repeatedly bent in the transverse direction (the direction perpendicular to the rolling direction). The actual measurement value corresponding to this prediction value was 2.10 mm.

The prediction value of the minimum bend radius, which allows the rolled material to withstand 200,000 bending repetitions, in the comparative example 2 is 1.46 mm when the rolled material is repeatedly bent in the transverse direction (the direction perpendicular to the rolling direction). The actual measurement value corresponding to this prediction value was 1.60 mm.

The prediction value of the minimum bend radius, which allows the rolled material to withstand 200,000 bending repetitions, in the comparative example 3 is 2.40 mm when the rolled material is repeatedly bent in the transverse direction (the direction perpendicular to the rolling direction). The actual measurement value corresponding to this prediction value was 2.30 mm.

According to the aforementioned results, the maximum difference between the prediction value and the actual measurement value obtained by the equation of minimum bend radius=(thickness×modulus of elasticity)/(0.0048×Vickers hardness+0.21) was 0.14 mm (comparative example 2). Here, a degree of the difference 0.14 mm can be considered as a margin of error, and it can be said that the prediction equation of the minimum bend radius is effective at designing actual minimum bend radii.

Table 6 provides a listing of prediction values of fatigue limits of the rolled materials 100 according to the examples 1 to 8, 18 and 19 that are obtained by using (0.0021×(Vickers hardness)+0.103), actual measurement values of the fatigue limits, and differences between the prediction values and the actual measurement values (actual measurement value−prediction value).

TABLE 6

| | | | | | | | Difference | |
|---|---|---|---|---|---|---|---|---|
| | | | Vickers | Elastic | | | bet. Actual & | |
| | Roll Material Composition | Finish | Hardness | Modulus | Actual Fatigue | Predicted Fatigue | Predicted | Bend |
| No. | (% mass) | Symbol | (HV) | (GPa) | Limit (GPa) | Limit (GPa) | Limits (GPa) | Direction |
| Ex. 1 | Ti—15V—3Cr—3Sn—3Al | H | 316 | 72 | 0.900 | 0.861 | +0.039 | RD |
| Ex. 2 | Ti—15V—3Cr—3Sn—3Al | H | 316 | 90 | 0.844 | 0.861 | −0.017 | TD |
| Ex. 3 | Ti—15V—3Cr—3Sn—3Al | H | 326 | 69 | 0.863 | 0.885 | −0.022 | RD |
| Ex. 4 | Ti—15V—3Cr—3Sn—3Al | H | 326 | 84 | 0.840 | 0.885 | −0.045 | TD |
| Ex. 5 | Ti—15V—3Cr—3Sn—3Al | HT | 480 | 109 | 1.258 | 1.255 | +0.003 | RD |
| Ex. 6 | Ti—15V—3Cr—3Sn—3Al | HT | 480 | 121 | 1.210 | 1.255 | −0.045 | TD |
| Ex. 7 | Ti—15V—3Cr—3Sn—3Al | O | 262 | 80 | 0.706 | 0.732 | −0.026 | RD |
| Ex. 8 | Ti—15V—3Cr—3Sn—3Al | O | 262 | 94 | 0.705 | 0.732 | −0.027 | TD |
| Ex. 18 | TR270C | H | 251 | 93 | 0.698 | 0.705 | −0.007 | RD |
| Ex. 19 | TR270C | H | 251 | 95 | 0.713 | 0.705 | +0.008 | TD |

The prediction value in the example 1 is 0.861 GPa when the rolled material is bent in the roll direction (rolling direction), and the actual measurement value corresponding to this prediction value was 0.900 GPa so that the difference between them is +0.039.

The prediction value in the example 2 is 0.861 GPa when the rolled material is bent in the transverse direction (the direction perpendicular to the rolling direction), and the actual measurement value corresponding to this prediction value was 0.844 GPa so that the difference between them is −0.017.

The prediction value in the example 3 is 0.885 GPa when the rolled material is bent in the roll direction (rolling direction), and the actual measurement value corresponding to this prediction value was 0.863 GPa so that the difference between them is −0.022.

The prediction value in the example 4 is 0.885 GPa when the rolled material is bent in the transverse direction (the direction perpendicular to the rolling direction), and the actual measurement value corresponding to this prediction value was 0.840 GPa so that the difference between them is −0.045.

The prediction value in the example 5 is 1.255 GPa when the rolled material is bent in the roll direction (rolling direction), and the actual measurement value corresponding to this prediction value was 1.258 GPa so that the difference between them is +0.003.

The prediction value in the example 6 is 1.255 GPa when the rolled material is bent in the transverse direction (the direction perpendicular to the rolling direction), and the actual measurement value corresponding to this prediction value was 1.210 GPa so that the difference between them is −0.045.

The prediction value in the example 7 is 0.732 GPa when the rolled material is bent in the roll direction (rolling direction), and the actual measurement value corresponding to this prediction value was 0.706 GPa so that the difference between them is −0.026.

The prediction value in the example 8 is 0.732 GPa when the rolled material is bent in the transverse direction (the direction perpendicular to the rolling direction), and the actual measurement value corresponding to this prediction value was 0.705 GPa so that the difference between them is −0.027.

The prediction value in the example 18 is 0.705 GPa when the rolled material is bent in the roll direction (rolling direction), and the actual measurement value corresponding to this prediction value was 0.698 GPa so that the difference between them is −0.007.

The prediction value in the example 19 is 0.705 GPa when the rolled material is bent in the transverse direction (the direction perpendicular to the rolling direction), and the actual measurement value corresponding to this prediction value was 0.713 GPa so that the difference between them is +0.008.

Table 7 provides a listing of prediction values of fatigue limits of the rolled materials 100 according to the examples 21 to 26, and the comparative examples 2 and 3 that are obtained by using (0.0024×(Vickers hardness)+0.103), actual measurement values of the fatigue limits, and differences between the prediction values and the actual measurement values (actual measurement value−prediction value).

TABLE 7

| | | | | | Actual | Predicted | Difference | |
|---|---|---|---|---|---|---|---|---|
| | | | Vickers | Elastic | Fatigue | Fatigue | bet. Actual | |
| | Rolled Material Composition | Finish | Hardness | Modulus | Limit | Limit | & Predicted | Bend |
| No. | (% Mass) | Symbol | (HV) | (GPa) | (GPa) | (GPa) | Limits (GPa) | Direction |
| Ex. 21 | SUS301 | EH—TA | 600 | 183 | 1.525 | 1.543 | −0.018 | RD |
| Ex. 22 | SUS301 | EH—TA | 600 | 211 | 1.583 | 1.543 | +0.040 | TD |
| Ex. 23 | SUS301 | EH—TA | 557 | 182 | 1.400 | 1.440 | −0.040 | RD |
| Ex. 24 | SUS316L | H | 438 | 155 | 1.107 | 1.154 | −0.047 | RD |
| Ex. 25 | YUS130S | H | 520 | 174 | 1.305 | 1.351 | −0.046 | RD |
| | (Fe—19Cr—11Mn—6Ni—0.35N—0.09C) | | | | | | | |
| Ex. 26 | YUS130S | H | 520 | 193 | 1.379 | 1.351 | +0.028 | TD |
| | (Fe—19Cr—11Mn—6Ni—0.35N—0.09C) | | | | | | | |
| Comp. Ex. 2 | SUS301 | EH—TA | 557 | 211 | 1.319 | 1.440 | −0.121 | TD |
| Comp. Ex. 3 | SUS316L | H | 438 | 185 | 1.207 | 1.154 | +0.053 | TD |

The prediction value in the example 21 is 1.543 GPa when the rolled material is bent in the roll direction (rolling direction), and the actual measurement value corresponding to this prediction value was 1.525 GPa so that the difference between them is −0.018.

The prediction value in the example 22 is 1.543 GPa when the rolled material is bent in the transverse direction (the direction perpendicular to the rolling direction), and the actual measurement value corresponding to this prediction value was 1.583 GPa so that the difference between them is +0.040.

The prediction value in the example 23 is 1.440 GPa when the rolled material is bent in the roll direction (rolling direction), and the actual measurement value corresponding to this prediction value was 1.400 GPa so that the difference between them is −0.040.

The prediction value in the example 24 is 1.154 GPa when the rolled material is bent in the roll direction (rolling direction), and the actual measurement value corresponding to this prediction value was 1.107 GPa so that the difference between them is −0.047.

The prediction value in the example 25 is 1.351 GPa when the rolled material is bent in the roll direction (rolling direction), and the actual measurement value corresponding to this prediction value was 1.305 GPa so that the difference between them is −0.046.

The prediction value in the example 26 is 1.351 GPa when the rolled material is bent in the transverse direction (the direction perpendicular to the rolling direction), and the actual measurement value corresponding to this prediction value was 1.379 GPa so that the difference between them is +0.028.

The prediction value in the comparative example 2 is 1.440 GPa when the rolled material is bent in the transverse direction (the direction perpendicular to the rolling direction), and the actual measurement value corresponding to this prediction value was 1.319 GPa so that the difference between them is −0.121.

The prediction value in the comparative example 3 is 1.154 GPa when the rolled material is bent in the transverse direction (the direction perpendicular to the rolling direction), and the actual measurement value corresponding to this prediction value was 1.207 GPa so that the difference between them is +0.053.

An average a of difference between the prediction value and the actual measurement value (actual measurement value−prediction value) is calculated at 0.041 from the results in Tables 6 and 7 so that variation 3σ is ±0.124. As a result, the inventor has found that the minimum bend radius is preferably set as the equation of minimum bend radius=(thickness×modulus of elasticity)/(0.0048×Vickers hardness+0.21−0.124×2), which can be rewritten as minimum bend radius=(thickness×modulus of elasticity)/(0.0048×Vickers hardness+0.21−0.25), that is, minimum bend radius=(thickness×modulus of elasticity)/(0.0048×Vickers hardness−0.04) when the minimum bend radius is set.

Table 8 provides a listing of measurement results of index values of durability against bending repetitions, densities, relative permeability, fatigue limit, and bend radius of the rolled materials 100 according to the examples 1, 15, 18, 21, 24, 25 and 27, and the comparative examples 2 to 4. Also, Table 8 provides a listing of values as levels, and rating scales of them. Calculation of the levels and definition of the rating scales are shown in Table 9.

TABLE 8

| | | Index | | | | | | | | | Fatigue | Bend |
|---|---|---|---|---|---|---|---|---|---|---|---|---|
| | | (Durability Against | | | Density | | | Relative Permeability | | | Limit | Rad. |
| | Roll Material Composition | Bending Repetitions) | | | (Weight Reduction) | | | (Non-Magnetizability) | | | (Act.) | (Act .) |
| No. | (% Mass) | HV/GPa | Level | Rating | g/cm² | Level | Rating | — | Level | Rating | GPa | mm |
| Ex. 1 | Ti—15V—3Cr—3Sn—3Al | 0.0240 | 100 | 1 | 4.76 | 63 | 3 | 1.00050 | 100 | 1 | 0.900 | 1.20 |
| Ex. 15 | Ti—36Nb—2Ta—3Zr—0.3O | 0.0228 | 90 | 1 | 5.60 | 48 | 3 | 1.00030 | 100 | 1 | N/A | N/A |
| Ex. 18 | TR270C | 0.0152 | 29 | 4 | 4.51 | 67 | 3 | 1.00030 | 100 | 1 | 0.698 | 2.00 |
| Ex. 21 | SUS301 | 0.0169 | 43 | 3 | 7.93 | 6 | 5 | 1.60000 | 0 | 5 | 1.525 | 1.80 |
| Ex. 24 | SUS316L | 0.0149 | 27 | 4 | 7.98 | 5 | 5 | 1.02100 | 97 | 1 | 1.107 | 2.10 |
| Ex. 25 | YUS130S | 0.0156 | 32 | 3 | 7.80 | 8 | 5 | 1.00190 | 100 | 1 | 1.305 | 2.00 |
| Ex. 27 | C1720 | 0.0160 | 35 | 3 | 8.26 | 0 | 5 | 1.00004 | 100 | 1 | N/A | N/A |
| Comp. Ex. 2 | SUS301 | 0.0137 | 17 | 4 | 7.93 | 6 | 5 | 1.60000 | 0 | 5 | 1.319 | 1.60 |
| Comp. Ex. 3 | SUS316L | 0.0125 | 7 | 5 | 7.98 | 5 | 5 | 1.02100 | 97 | 1 | 1.207 | 2.30 |
| Comp. Ex. 4 | A5052 | 0.0116 | 0 | 5 | 2.68 | 100 | 1 | 1.00020 | 100 | 1 | N/A | N/A |

TABLE 9

| Rating | Rating Scale | | |
|---|---|---|---|
| Scale | (Designation) | Level | Definition of Level (%) |
| 1 | high | 90 to 100 | Level (%) = (Subject Value − |
| 2 | slightly above | 70 to 90 | Min. Value)/(Max. Value − Min. |
| | | | Value) × 100 |
| | | | If Higher Value is Better (Index) |
| 3 | average | 30 to 70 | Level (%) = 100 − (Subject |
| 4 | slightly below | 10 to 30 | Value − Min. Value)/(Max. |
| 5 | low | 0 to 10 | Value − Min. Value) × 100 |
| | | | If Lower Value is Better |
| | | | (Density, Relative Permeability) |

The rating scales include rating scale 1 corresponding to not smaller than level 90 and not greater than level 100, rating scale 2 corresponding to not smaller than level 70 and smaller than 90, rating scale 3 corresponding to not smaller than level 30 and smaller than 70, rating scale 4 corresponding to not smaller than level 10 and smaller than 30, and rating level 5 corresponding to not smaller than 0 and smaller than 10. Rating scale 1 designates high (higher than average), rating scale 2 designates slight above (slightly higher than average), rating scale 3 designates average, rating scale 4 designates slight below (slightly lower than average), and rating scale 5 designates low (lower than average).

As shown in Table 9, the higher the level of the index value, the higher the durability against bending repetitions, and for this reason it is preferable that the level is higher. From this viewpoint, the level of the index value is obtained by an equation of {a value that is obtained by subtracting the minimum value from a value (subject value) from which the level of the index value is calculated (subject value−minimum value)}/{a value that is obtained by subtracting the minimum value from the maximum value (maximum value−minimum value)}×100. For example, to obtain the level of the index value in the example 1, the subject value is 0.240, the maximum value of the index values in Table 8 is 0.240, which is the index value in the example 1, and the minimum value of the index values is 0.0116, which is the index value in the comparative example 4 so that the level of the index value in the example 1 is obtained as (0.240−0.116)/(0.240−0.116)×100=100.

Contrary to this, the smaller the relative permeability, the smaller the magnetizability so that the rolled material having smaller relative permeability is evaluated higher. Also, the smaller the density, the lighter the rolled material so that the rolled material having a smaller density is evaluated higher. From this viewpoint, in order that the rolled material having a smaller level can be evaluated higher, the level of the relative permeability or the density is obtained by 100−{(subject value−minimum value)/(a value that is obtained by subtracting the minimum value from the maximum value) (maximum value−minimum value)×100}.

The index value, the level of the index value, and the rating scale in the example 1 are 0.0240 HV/GPa, 100, and 1, respectively. Also, the density, the level of the index value, and the rating scale in the example 1 are 4.76 g/cm³, 63, and 3, respectively. The relative permeability, the level of the index value, and the rating scale in the example 1 are 1.00050, 100, and 1, respectively. The fatigue limit and the bend radius in the example 1 are 0.90 GPa and 1.20 mm, respectively.

The index value, the level of the index value, and the rating scale in the example 15 are 0.0228 HV/GPa, 90, and 1, respectively. Also, the density, the level of the index value, and the rating scale in the example 15 are 5.60 g/cm³, 48, and 3, respectively. The relative permeability, the level of the index value, and the rating scale in the example 15 are 1.00030, 100, and 1, respectively.

The index value, the level of the index value, and the rating scale in the example 18 are 0.0152 HV/GPa, 29, and 4, respectively. Also, the density, the level of the index value, and the rating scale in the example 18 are 4.51 g/cm³, 67, and 3, respectively. The relative permeability, the level of the index value, and the rating scale in the example 18 are 1.00030, 100, and 1, respectively. The fatigue limit and the bend radius in the example 18 are 0.698 GPa and 2.00 mm, respectively.

The index value, the level of the index value, and the rating scale in the example 21 are 0.0169 HV/GPa, 43, and 3, respectively. Also, the density, the level of the index value, and the rating scale in the example 21 are 7.93 g/cm³, 6, and 5, respectively. The relative permeability, the level of the index value, and the rating scale in the example 21 are 1.60000, 0, and 5, respectively. The fatigue limit and the bend radius in the example 21 are 1.525 GPa and 1.80 mm, respectively.

The index value, the level of the index value, and the rating scale in the example 24 are 0.0149 HV/GPa, 27, and 4, respectively. Also, the density, the level of the index value, and the rating scale in the example 24 are 7.98 g/cm³, 5, and 5, respectively. The relative permeability, the level of the index value, and the rating scale in the example 24 are 1.02100, 97, and 1, respectively. The fatigue limit and the bend radius in the example 24 are 1.107 GPa and 2.10 mm, respectively.

The index value, the level of the index value, and the rating scale in the example 25 are 0.0156 HV/GPa, 32, and 3, respectively. Also, the density, the level of the index value, and the rating scale in the example 25 are 7.80 g/cm³, 8, and 5, respectively. The relative permeability, the level of the index value, and the rating scale in the example 25 are 1.00190, 100, and 1, respectively. The fatigue limit and the bend radius in the example 25 are 1.305 GPa and 2.00 mm, respectively.

The index value, the level of the index value, and the rating scale in the example 27 are 0.0160 HV/GPa, 35, and 3, respectively. Also, the density, the level of the index value, and the rating scale in the example 27 are 8.26 g/cm³, 0, and 5, respectively. The relative permeability, the level of the index value, and the rating scale in the example 27 are 1.00004, 100, and 1, respectively.

The index value, the level of the index value, and the rating scale in the comparative example 2 are 0.0137 HV/GPa, 17, and 4, respectively. Also, the density, the level of the index value, and the rating scale in the comparative example 2 are 7.93 g/cm³, 6, and 5, respectively. The relative permeability, the level of the index value, and the rating scale in the comparative example 2 are 1.60000, 0, and 5, respectively. The fatigue limit and the bend radius in the comparative example 2 are 1.319 GPa and 1.60 mm, respectively.

The index value, the level of the index value, and the rating scale in the comparative example 3 are 0.0125 HV/GPa, 7, and 5, respectively. Also, the density, the level of the index value, and the rating scale in the comparative example 3 are 7.98 g/cm³, 5, and 5, respectively. The relative permeability, the level of the index value, and the rating scale in the comparative example 3 are 1.02100, 97, and 1, respectively. The fatigue limit and the bend radius in the comparative example 3 are 1.207 GPa and 2.30 mm, respectively.

The index value, the level of the index value, and the rating scale in the comparative example 4 are 0.0116 HV/GPa, 0, and 5, respectively. Also, the density, the level of the index value, and the rating scale in the comparative example 4 are 2.68 g/cm³, 100, and 1, respectively. The relative permeability, the level of the index value, and the rating scale in the comparative example 4 are 1.00020, 100, and 1, respectively.

Table 10 provides a summary of rating scales of index values of durability against bending repetitions, rating scales of densities, and rating scales of relative permeabilities of the materials based on the results in Table 8.

TABLE 10

| | | Index of | | |
|---|---|---|---|---|
| | | durability | | Relative |
| | | Against | Density | Permeability |
| | | Bending | (Weight | (Non-Magne- |
| | Composition | Repetitions | Reduction) | tizability) |
| Ex. | Titanium Alloy | 1 | 3 | 1 |
| Ex. | Stainless (SUS) | 3.4 | 5 | 1.5 |
| Ex. | Copper Alloy | 2 | 5 | 1 |
| Comp. | Stainless (SUS) | 4.5 | 5 | 1.5 |
| Ex. | | | | |
| Comp. | Aluminum Alloy | 5 | 1 | 1 |
| Ex. | | | | |

The rating scales of the index values of durability of titanium alloys in the examples 1 and 15 are 1. Also, the rating scales of their densities are 3. Also, the rating scales of their relative permeabilities are 1.

The rating scales of index values of durability of stainless steel (SUS) in the examples 21, 24 and 25 are 3 or 4. Also, the rating scales of their densities are 5. Also, the rating scales of their relative permeabilities are 1 or 5.

The rating scale of index value of durability of a copper alloy in the example 27 is 2. Also, the rating scale of its density is 5. Also, the rating scale of its relative permeability is 1.

The rating scales of index values of durability of stainless steel (SUS) in the comparative examples 2 and 3 are 4 or 5. Also, the rating scales of their densities are 5. Also, the rating scales of their relative permeabilities are 1 or 5.

The rating scale of index value of durability of an aluminum alloy in the comparative example 4 is 5. Also, the rating scale of its density is 1. Also, the rating scale of its relative permeability is 1.

As shown in Table 10, the rating scales of the index values of the titanium alloys are sufficiently higher than the rating scales of the index values of the stainless steel. For this reason, the titanium alloys are clearly better than the stainless steel from the viewpoint of durability against bending repetitions.

Also, the rating scales of the densities of the titanium alloys are sufficiently higher than the rating scales of the densities of the stainless steel. For this reason, the titanium alloys are better than the stainless steel from the viewpoint of weight reduction.

Also, the rating scales of the relative permeabilities of the titanium alloys are higher than the rating scales of the relative permeabilities of the stainless steel. For this reason, the titanium alloys are better than the stainless steel from viewpoint of non-magnetizability.

The inventor of the present application has found that that titanium alloys are more preferably used than stainless steel.

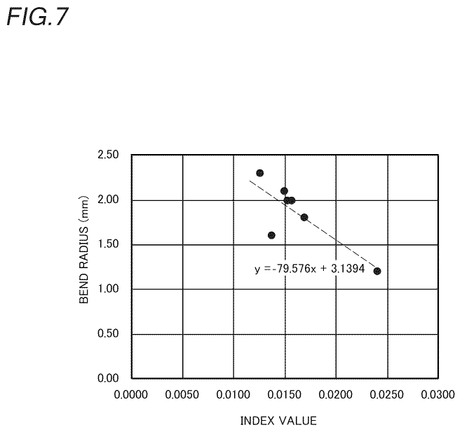

FIG. 7 is a graph showing a line plotted by placing items points corresponding to a vertical axis as bend radius and a horizontal axis as index value. Also, the items in the graph of FIG. 7 are placed in accordance with the bend radii and the index values shown in Table 8. The line in the graph of FIG. 7 is represented by y=−79.576x+3.1394. The inventor has found that the higher the index value, the smaller the bend radius from the result in FIG. 7.

### Modified Embodiments

Note that the embodiment and the example disclosed this time must be considered as illustrative in all points and not restrictive. The scope of the present invention is not shown by the above description of the embodiment and the example but by the scope of claims for patent, and all modifications (modified embodiments) within the meaning and scope equivalent to the scope of claims for patent are further included.

While the example in which the rolled material is used for the display apparatus has been shown in the aforementioned embodiment, the present invention is not limited to this. In the present invention, the rolled material may be used, for example, for a spring in a contact of a switch.

Although the titanium alloys are illustratively shown as beta-type titanium alloys, the present invention is not limited to these.

1. A rolled material to be used for a foldable or curvable part comprising an alloy or a pure metal, wherein
a value that is obtained by the following equation (1) is used as an index value of durability against bending repetitions, and the index value of the rolled material is not smaller than 0.014 HV/GPa, and
the rolled material has a thickness not greater than 0.03 mmm and a maximum value of a foldable or curvable bend radius of the rolled material that is actually measured is not greater than 2.1 mm,
$$index value = ( 0.0048 \times ( Vickers hardness ) + 0.21 ) / ( modulus of elasticity ) . \qquad ( 1 )$$

2. The rolled material according to claim 1, wherein the index value of the rolled material is not smaller than 0.019 HV/GPa.

3. The rolled material according to claim 1, wherein the pure metal is pure titanium.

4. The rolled material according to claim 1, wherein the alloy is a beta-type titanium alloy, austenitic stainless steel, or beryllium copper.

5. The rolled material according to claim 4, wherein the beta-type titanium alloy comprises not smaller than 14.0 mass % and not greater than 16.0 mass % of V, not smaller than 2.5 mass % and not greater than 3.5 mass % of Cr, not smaller than 2.5 mass % and not greater than 3.5 mass % of Sn, and not smaller than 2.5 mass % and not greater than 3.5 mass % of Al.

6. The rolled material according to claim 1, wherein a value that is obtained by the following equation (2) is used as a prediction value of a minimum bend radius to which the rolled material is foldable or curvable, and the prediction value of the minimum bend radius of the rolled material whose thickness is 0.03 mm is not greater than 2.14 mm,
minimum bend radius=(thickness×modulus of elasticity)/(0.0048×Vickers hardness+0.21) (2).

7. The rolled material according to claim 1, wherein the rolled material is used for a foldable or curvable support (2) supporting a display (1) of a display apparatus (200).

8. The rolled material according to claim 1, wherein the rolled material has a thickness not greater than 0.03 mm, and a maximum value of a foldable or curvable bend radius of the rolled material that is actually measured is not greater than 2.1 mm.

9. The rolled material according to claim 1, wherein the index value of the rolled material is not smaller than 0.014 HV/GPa and not greater than 0.029 HV/GPa.
